(19) United States
(12) Patent Application Publication
(10) Pub. No.: US 2007/0127889 A1
(43) Pub. Date: Jun. 7, 2007

(54) Method and apparatus for providing audio content selection information, generating and providing thumbnail of audio content, and recording medium storing program for performing the method

(75) Inventor: Hyung-Jin Seo, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/602,182

(22) Filed: Nov. 21, 2006

(30) Foreign Application Priority Data
Dec. 1, 2005 (KR) 10-2005-0116638

(51) Int. Cl. H04N 7/00

(52) U.S. Cl. 386/96

(57) ABSTRACT

A method and apparatus for providing information allowing a user to select an audio content desired to be reproduced based on a visual thumbnail of the audio content, and a recording medium storing a program for performing the method are provided. The method includes analyzing additional information and frequencies of a plurality of audio contents stored in the audio content storage and reproducing system, generating visual thumbnails corresponding to the respective audio contents based on the result of the analyzing and function information of the audio content storage and reproducing system, and displaying the visual thumbnails as the audio content selection information when the audio content selection information is requested.

This application claims priority from Korean Patent Application No. 10-2005-0116638, filed on Dec. 1, 2005, in the Korean Intellectual Property Office, the disclosure of which is incorporated herein in its entirety by reference.

### BACKGROUND OF THE INVENTION

1. Field of the Invention

Methods and apparatuses and systems consistent with the present invention relate to for providing audio content selection information in an audio content storage and reproducing system having a display, generating and providing a thumbnail of an audio content, and a recording medium storing a program for performing the same.

2. Description of the Related Art

A portable music player (PMP), an MP3 player, and a home server are examples of an audio content storage and reproducing system having a display. An audio content storage and reproducing system typically includes a storage device such as a hard disk drive (HDD) having a large capacity and thus can store several hundreds to thousands of music titles as audio contents.

When a user wants to select an audio content to be reproduced from among audio contents stored in a related audio content storage and reproducing system, the audio content storage and reproducing system provides titles or detailed information of the stored audio contents as audio content selection information. Accordingly, when the user does not know the title or detailed information of an audio content, it is difficult to select a desired audio content to be reproduced.

To overcome this problem, audio content storage and reproducing systems having an intro function that reproduces a particular section of audio in an audio content to allow a user to recognize the audio content. However, since the user needs to listen to the audio reproduced for a period of time corresponding to the length of the section of each audio content, it may take a large amount of time to select a desired audio content.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and apparatus for providing information allowing a user to select an audio content desired to be reproduced based on a visual thumbnail of the audio content, and a recording medium storing a program for performing the method.

The present invention further provides a method and apparatus for generating and providing a thumbnail corresponding to audio content.

According to an aspect of the present invention, there is provided a method of providing audio content selection information in an audio content storage and reproducing system, the method including: analyzing additional information and frequencies of a plurality of audio contents stored in the audio content storage and reproducing system; generating visual thumbnails corresponding to the respective audio contents based on the result of the analyzing and function information of the audio content storage and reproducing system; and displaying the visual thumbnails as the audio content selection information.

According to another aspect of the present invention, there is provided an apparatus for providing audio content selection information in an audio content storage and reproducing system, the apparatus including: a storage unit for storing a plurality of audio contents and additional information of the audio contents; an analyzer for analyzing the additional information and frequencies of the audio contents stored in the storage unit; a function information provider for providing function information of the audio content storage and reproducing system; a thumbnail generator for generating visual thumbnails corresponding to the audio contents, respectively, based on information provided from the analyzer and information provided from the function information provider and storing the visual thumbnails in the storage unit; and a display unit for displaying the visual thumbnails provided from the storage unit in response to a request for the audio content selection information.

According to still another aspect of the present invention, there is provided a computer readable recording medium for storing a program for performing a method of providing audio content selection information in an audio content storage and reproducing system, the computer readable recording medium including: a code for analyzing additional information and frequencies of a plurality of audio contents stored in the audio content storage and reproducing system; a code for generating visual thumbnails corresponding to the respective audio contents based on the result of the analyzing and function information of the audio content storage and reproducing system; and a code for displaying the visual thumbnails as the audio content selection information when the audio content selection information is requested.

According to yet another aspect of the present invention, there is provided a method for generating a thumbnail of an audio content, the method including analyzing the audio content; and generating a visual thumbnail corresponding to the audio content based on a result of the analyzing operation.

According to another aspect of the present invention, there is provided a method for providing a thumbnail of an audio content, the method including storing a visual thumbnail corresponding to the audio content; and displaying the stored visual thumbnail.

According to another aspect of the present invention, there is provided an apparatus for generating a thumbnail of an audio content, the apparatus including an analyzer which analyzes the audio content; and a thumbnail generator which generates a visual thumbnail corresponding to the audio content based on the a result determined by the analyzer. The analyzer also may analyze at least one of additional information and a frequency of the audio content. The thumbnail generator also may generate the visual thumbnail based on the result of the analyzing and function information of an audio content reproducing system capable of reproducing the visual thumbnail.

According to another aspect of the present invention, there is provided an apparatus for providing a thumbnail of an audio content, the apparatus including a storage unit which stores a visual thumbnail corresponding to the audio content; and a display unit which displays the stored visual thumbnail.

### BRIEF DESCRIPTION OF THE DRAWINGS

The above and other aspects of the present invention will become more apparent by describing in detail exemplary embodiments thereof with reference to the attached drawings in which:

FIG. 1 is a functional block diagram of an apparatus for providing audio content selection information according to an exemplary embodiment of the present invention;

FIG. 2 illustrates a visual thumbnail generated according to an exemplary embodiment of the present invention;

FIG. 3 illustrates the application of an apparatus for providing audio content selection information according to an exemplary embodiment of the present invention;

FIG. 4 is a flowchart of a method of providing audio content selection information according to an exemplary embodiment of the present invention; and

FIG. 5 is a flowchart of a method of providing audio content selection information according to another exemplary embodiment of the present invention.

### DETAILED DESCRIPTION OF THE EXEMPLARY EMBODIMENTS OF THE INVENTION

Hereinafter, exemplary embodiments of the present invention will be described in detail with reference to the attached drawings. In the drawings, the same reference numerals denote the same member.

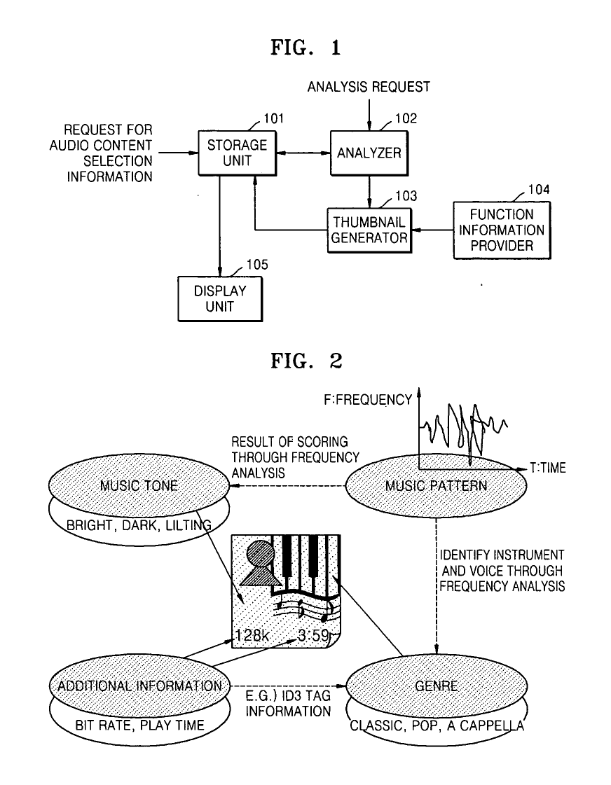

FIG. 1 is a functional block diagram of an apparatus for providing audio content selection information according to an exemplary embodiment of the present invention. Referring to FIG. 1, the apparatus includes a storage unit 101, an analyzer 102, a function information provider 104, a thumbnail generator 103, and a display unit 105.

The storage unit 101 stores audio contents, additional information of each audio content, and visual thumbnails generated by the thumbnail generator 103. The additional information may include a bit rate, a play time, a genre, and an artist for each audio content. When an audio content storage and reproducing system is an MP3 player, the additional information can be obtained from an additional information area according to an ID3 tag or MP3 format. Alternatively, when an audio content storage and reproducing system stores audio contents in a file format, the additional information can be obtained from a header area of an audio file. The audio content and its additional information may be combined into a single audio content file. The visual thumbnail may be stored in the additional information area for the audio content.

Upon receiving an analysis request, the analyzer 102 analyzes the additional information of each audio content stored in the storage unit 101 and the frequency of the audio content, thereby obtaining information needed to generate a visual thumbnail corresponding to the audio content. In other words, in response to the analysis request, the analyzer 102 analyzes the frequency of the audio content to obtain a frequency score 1 or a music pattern. Here, the analyzer 102 may analyze the frequency throughout the entire audio content or through sampling at specified intervals. Whether to analyze the frequency throughout the entire audio content or to analyze the frequency through sampling at specified intervals may be determined by a user or according to the resource of the audio content storage and reproducing system. For example, when the resource of the audio content storage and reproducing system is not sufficient, sampling at specified intervals may be used to analyze the frequency of the audio content. The specified intervals may vary with the amount of resource of the audio content storage and reproducing system.

The analyzer 102 calculates at least one music tone value based on the frequency score or music pattern. If it is determined that a low frequency is repeated in a specified range at a specified occurrence frequency for a specified period of time and sound is slow or audio is not generated, based on the frequency score obtained with respect to the audio content, the analyzer 102 calculates a music tone at a negative value to indicate that the audio content is gloomy or dark music.

If it is determined that a frequency pattern in a specified range is quickly and periodically repeated and a pitch is high, based on the frequency score, the analyzer 102 calculates the music tone at a positive value to indicate that the audio content is lilting music.

The analyzer 102 obtains genre information based on the result of analyzing the frequency of the audio content and genre information included in the additional information read from the storage unit 101. When analyzing the frequency of the audio content to obtain the genre information, the analyzer 102 may utilize information on musical instruments sounding in a particular frequency band and information on human voice's range.

In addition, the analyzer 102 analyzes the additional information stored in the storage unit 101 to obtain additional information needed to generate a visual thumbnail. In an exemplary embodiment of the present invention, the analyzer 102 may obtain a bit rate and a play time as the additional information needed to generate the visual thumbnail. However, the additional information needed to generate the visual thumbnail is not restricted to the bit rate and the play time.

The function information provider 104 provides function information of the audio content storage and reproducing system. The function information is needed to generate the visual thumbnail and may include a display resolution, a color value, a font size or basic information display unit, and a display scheme. For example, the display scheme may include information on how many lines of visual thumbnail will be listed up.

The thumbnail generator 103 generates a visual thumbnail corresponding to each of the audio contents stored in the storage unit 101 based on information received from the analyzer 102 and information received from the function information provider 104. In detail, the thumbnail generator 103 determines the size of thumbnails based on display resolution information provided from the function information provider 104. For example, when three lines of thumbnails are listed up with a font size of 80×100 pixels and at a display resolution of 600×300 pixels, the size of the thumbnails is calculated at 80×100 pixels.

In addition, the thumbnail generator 103 determines background color of each thumbnail based on a music tone value. In detail, the thumbnail generator 103 determines saturation of color set by a user or basic background color provided from the function information provider 104 or its complement color based on an at least one music tone value obtained by the analyzer 102 with respect to an audio content. For example, when the background color of a thumbnail is determined based on an average of music tone values obtained with respect to an audio content, if the average of music tone values has a negative value, the thumbnail generator 103 decreases the saturation of the basic background color of the thumbnail by the negative value. If the average of music tone values has a positive value, the thumbnail generator 103 increases the saturation of the basic background color of the thumbnail by the positive value.

Alternatively, when the thumbnail generator 103 determines the background color of each thumbnail based on the change of a music tone value over time, the thumbnail generator 103 may give gradation corresponding to a negative or positive music tone value to the basic background color to each horizontal or vertical pixel unit corresponding to a frequency analysis interval in the size of the thumbnail.

Also, the thumbnail generator 103 determines an object item based on genre information provided from the analyzer 102. The thumbnail generator 103 may select one object item from among predefined object items expressed in graphic patterns such as the shapes of a piano, person, and drum. If the genre information does not correspond to any one of the predefined object items, the thumbnail generator 103 may select an object item most approximate to the genre information from among the predefined object item.

The thumbnail generator 103 may determine the object item corresponding to the genre information using a mixed item including similar items or a default item. For example, a mixed item in which the shapes of piano, drum and string instrument are displayed together may be used as an object item. This mixed item may be used when the genre information of an audio content indicates an orchestra. In another example, when the genre information indicates female solo plus piano, the thumbnail generator 103 may determine a mixed item displaying the shapes of piano and female together as the object item. The default item may be a treble clef.

The thumbnail generator 103 may generate a thumbnail such that additional information provided from the analyzer 102 is displayed in a particular area, for example, a lower portion of the thumbnail.

FIG. 2 illustrates a visual thumbnail generated by the thumbnail generator 103 described above. Referring to FIG. 2, the visual thumbnail includes music tone information, genre information, and additional information of an audio content. The music tone information may be expressed by the monotonous background color of the visual thumbnail. Alternatively, the music tone information may be expressed by the background color gradated in horizontal or vertical pixel units or at intervals according to the change of music tone over time so that a user can recognize an audio section of gloomy tone and an audio section of lilting tone and their distribution in the audio content.

The thumbnail generator 103 stores such visual thumbnail in the storage unit 101. The visual thumbnail may be stored separately from a corresponding audio content file or may be embedded into a particular area of the audio content file. For example, for an MP3 player, the thumbnail generator 103 may store the visual thumbnail in an additional area of an ID3 tag as an EXchangeable Image File (EXIF). As a result, the storage unit 101 stores visual thumbnails by audio contents.

When audio content selection information is requested after visual thumbnails are respectively stored for all of audio contents, the storage unit 101 provides the visual thumbnails to the display unit 105. Then, the display unit 105 displays the visual thumbnails as the audio content selection information.

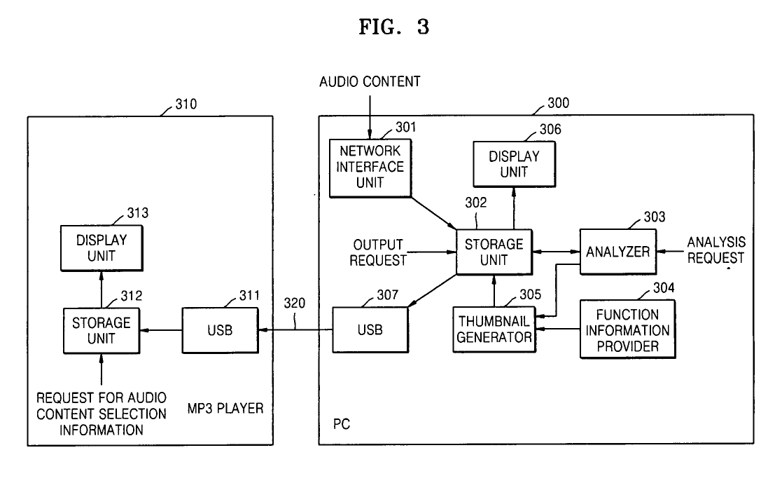

FIG. 3 illustrates the application of an apparatus for providing audio content selection information according to an exemplary embodiment of the present invention. Referring to FIG. 3, personal computer (PC) 300 generates visual thumbnails for audio contents and then provides them to an MP3 player 310 connected thereto. The MP3 player 310 stores the audio contents together with the received visual thumbnails. When audio content selection information is requested, the MP3 player 310 displays the visual thumbnails. In other words, the visual thumbnails corresponding to the respective audio contents are generated using the resources of the PC 300 and the MP3 player 310 receives the visual thumbnails from the PC 300 and reproduces them.

When the PC 300 is in an idle state and an audio content is transmitted to the MP3 player 310, the PC 300 generates a visual thumbnail and then transmits it to the MP3 player 310. The PC 300 may transmit the visual thumbnail separately from an audio file including the corresponding audio content or may embed the visual thumbnail into the corresponding audio file through a USB line 320.

For the above-described operation, the PC 300 includes a network interface unit 301, a storage unit 302, an analyzer 303, a function information provider 304, a thumbnail generator 305, a display unit 306, and a universal serial bus (USB) 307.

The network interface unit 301 receives audio contents through a network, such as the Internet and stores them in the storage unit 302. However, the PC 300 may receive audio contents from memory (not shown) or other external storage devices (not shown) without using the network interface unit 301.

The structures and operations of the storage unit 302, the analyzer 303, the function information provider 304, the thumbnail generator 305, and the display unit 306 are the same as those of the storage unit 101, the analyzer 102, the function information provider 104, the thumbnail generator 103, and the display unit 105 illustrated in FIG. 1.

Upon receiving an output request corresponding to audio content transmission, the storage unit 302 outputs an audio content file and a corresponding visual thumbnail to the USB 307. Then, the USB 307 transmits the audio content file and the corresponding visual thumbnail to the MP3 player 310 through the USB line 320.

Upon receiving an output request corresponding to the output of audio content selection information, the storage unit 302 outputs visual thumbnails stored therein to the display unit 306. Then, the display unit 306 displays the visual thumbnails corresponding to audio contents.

The MP3 player 310 includes a USB 311, a storage unit 312, a display unit 313. The USB 311 receives an audio content file and a corresponding visual thumbnail from the PC 300 and stores them in the storage unit 312.

Upon receiving a request for audio content selection information, the storage unit 312 provides visual thumbnails received therein to the display unit 313. The display unit 313 displays the visual thumbnails configured as shown in FIG. 2 for respective audio contents.

When the MP3 player 310 has sufficient resources to generate visual thumbnails, it is structured as shown in FIG. 1 so that it generates a visual thumbnail for an audio content and displays the visual thumbnail in response to the request for audio content selection information. Here, frequency analysis may be performed throughout the entire audio content or at intervals according to the resources of the MP3 player 310 or a user's request. The intervals may vary with the resources (or performance) of the MP3 player 310 or the user's request.

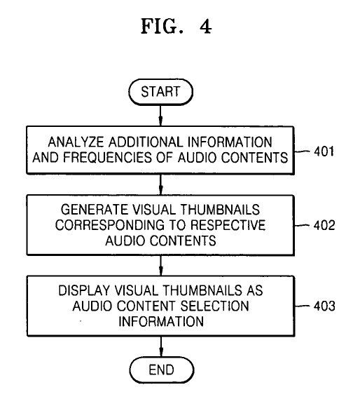

FIG. 4 is a flowchart of a method of providing audio content selection information according to an exemplary embodiment of the present invention. Referring to FIG. 4, additional information and frequencies of a plurality of audio contents stored in an audio content storage and reproducing system are analyzed in operation 401. The analyzing of the additional information and the frequencies has been described with reference to FIG. 1 above.

In operation 402, visual thumbnails corresponding to the respective audio contents are generated based on the result of the analyzing and function information of the audio content storage and reproducing system. The visual thumbnails are generated by the thumbnail generator 103 as described with reference to FIG. 1 above. Accordingly, each of the visual thumbnails may include music tone information, genre information, and additional information, as shown in FIG. 2.

When audio content selection information is requested, the visual thumbnails are displayed as the audio content selection information in operation 403, so that a user can select an audio content to be reproduced.

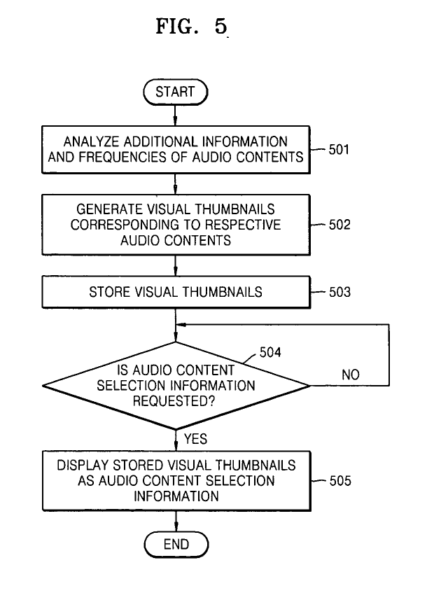

FIG. 5 is a flowchart of a method of providing audio content selection information according to another exemplary embodiment of the present invention. Referring to FIG. 5, when audio content selection information is requested, stored visual thumbnails are displayed as audio content selection information.

In detail, in operation 501, additional information and frequencies of a plurality of audio contents stored in an audio content storage and reproducing system are analyzed. The analyzing of the additional information and the frequencies is performed by the analyzer described with reference to FIG. 1 above.

In operation 502, visual thumbnails corresponding to the respective audio contents are generated based on the result of the analyzing and function information of the audio content storage and reproducing system. The visual thumbnails are generated by the thumbnail generator 103 as described with reference to FIG. 1 above.

In operation 503, the visual thumbnails are stored. When audio content selection information is requested in operation 504, the stored visual thumbnails are displayed as the audio content selection information in operation 505 so that a user can select an audio content to be reproduced.

A program for performing a method of providing audio content selection information according to the present invention can also be embodied exemplarily as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, according to an exemplary embodiment the present invention, visual thumbnails corresponding respective audio contents are provided so that a user can intuitively select an audio content desired to be reproduced in an audio content storage and reproducing system having a display. Accordingly, even when the user does not have any information on the desired audio content, the user can quickly select the desired audio content.

In addition, a visual thumbnail can comprehensively express a music tone, a genre, and additional information of an audio content and can express the change of the music tone in the audio content. Since such visual thumbnail is provided as audio content selection information, selection information discriminated from that provided according to the related art can be provided to a user.

Similar exemplary embodiments of the present invention to those listed above may also provide a method and an apparatus for generating a thumbnail of audio content and a method and an apparatus for providing a thumbnail of audio content.

The method for generating the thumbnail of the audio content may include analyzing the audio content; and generating an visual thumbnail corresponding to the audio content based on a result of the analyzing operation. The method can further include displaying and storing the visual thumbnail.

The analyzing the audio content may include analyzing at least one of additional information and a frequency of the audio content. The generating the visual thumbnail corresponding to the audio content based on the result of the analyzing operation may include generating the visual thumbnail based on the result of the analyzing operation and function information of an audio content reproducing system capable of reproducing the visual thumbnail.

Another method for providing a thumbnail of audio content may include storing an visual thumbnail corresponding to the audio content; and displaying the stored visual thumbnail.

The apparatus for generating a thumbnail of audio content may include an analyzer which analyzes the audio content; and a thumbnail generator which generates a visual thumbnail corresponding to the audio content based on the a result of the analyzing by the analyzer. The analyzer may analyze at least one of additional information and a frequency of the audio content. The thumbnail generator may generate the visual thumbnail based on the result of the analyzing operation and function information of an audio content reproducing system capable of reproducing the visual thumbnail.

The apparatus for providing a thumbnail of audio content may include a storage unit which stores a visual thumbnail corresponding to the audio content; and a display unit which displays the stored visual thumbnail.

According to the method and the apparatus for generating a thumbnail of audio content and the method and the apparatus for providing a thumbnail of audio content, the present can display a thumbnail of audio content using another display device such as a computer without directly displaying in an apparatus for generating the thumbnail of the audio content. In addition, an exemplary embodiment of the present invention may generate a thumbnail of audio content which is broadcasted by real time as well as a thumbnail of audio content stored in an apparatus.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of providing audio content selection information, the method comprising:
analyzing additional information and frequencies of a plurality of audio contents stored in an audio content storage and reproducing system;
generating visual thumbnails corresponding to the respective audio contents based on a result of the analyzing and function information of the audio content storage and reproducing system; and
displaying the visual thumbnails as the audio content selection information.

2. The method of claim 1, wherein the function information comprises at least one of a display information, a color value, and a font size;

3. The method of claim 1, wherein the additional information comprises at least one of a bit rate, a play time, a genre, and an artist.

4. The method of claim 1, wherein each of the visual thumbnails comprises music tone information, genre information, and additional information of a corresponding one of the audio contents.

5. The method of claim 4, wherein the additional information comprises at least one of a bit rate, a play time, a genre, and an artist.

6. The method of claim 1, further comprising:
storing the visual thumbnails; and
displaying the visual thumbnails, which are stored, as the audio content selection information if the audio content selection information is requested.

7. An apparatus for providing audio content selection information in an audio content storage and reproducing system, the apparatus comprising:
a storage unit which stores a plurality of audio contents and additional information of the audio contents;
an analyzer which analyzes the additional information and frequencies of the audio contents stored in the storage unit;
a function information provider which provides function information of the audio content storage and reproducing system;
a thumbnail generator which generates visual thumbnails corresponding to the audio contents, based on the information provided from the analyzer and the information provided from the function information provider and stores the generated visual thumbnails in the storage unit; and
a display unit which generates the visual thumbnails provided from the storage unit in response to a request for the audio content selection information.

8. The apparatus of claim 7, wherein the additional information comprises at least one of a bit rate, a play time, a genre, and an artist.

9. The apparatus of claim 7, wherein the functional information comprises at least one of a display information, a color value, and a font size.

10. The apparatus of claim 7, wherein each of the visual thumbnails comprises music tone information, genre information, and additional information of a corresponding one of the audio contents.

11. The apparatus of claim 10, wherein the additional information comprises at least one of a bit rate, a play time, a genre, and an artist.

12. An apparatus for providing audio content selection information in an audio content storage and reproducing system, the apparatus comprising:
a storage unit which stores a plurality of audio contents and visual thumbnails corresponding to the audio contents; and
a display unit which displays the visual thumbnails providing from the storage unit according to request audio content selection information as the audio content selection information.

13. The apparatus of claim 12, further comprising:
a Universal Serial Bus (USB) which receives the plurality of audio contents and the visual thumbnails corresponding to the audio contents and stores them in the storage unit.

14. The apparatus of claim 12, wherein each of the visual thumbnails comprises music tone information, genre information, and additional information of a corresponding one of the audio contents.

15. The apparatus of claim 14, wherein the additional information comprises at least one of a bit rate, a play time, a genre, and an artist.

16. A computer readable recording medium which stores a program for performing a method of providing audio content selection information in an audio content storage and reproducing system, the computer readable recording medium comprising:
a code for analyzing additional information and frequencies of a plurality of audio contents stored in the audio content storage and reproducing system;
a code for generating visual thumbnails corresponding to the respective audio contents based on a result of the analyzing and function information of the audio content storage and reproducing system; and
a code for displaying the visual thumbnails as the audio content selection information when the audio content selection information is requested.

17. A method for generating a thumbnail corresponding to audio content, the method comprising:
analyzing the audio content; and
generating a visual thumbnail corresponding to the audio content based on a result of the analyzing operation.

18. The method of claim 17, further comprising displaying the visual thumbnail.

19. The method of claim 17, further comprising storing the visual thumbnail.

20. The method of claim 17, wherein the analyzing the audio content comprises analyzing at least one of additional information and a frequency of the audio content.

21. The method of claim 17, wherein the generating the visual thumbnail comprises generating the visual thumbnail based on the result of the analyzing and function information of an audio content reproducing system capable of reproducing the visual thumbnail.

22. A method for providing a thumbnail of audio content, the method comprising:
storing a visual thumbnail corresponding to the audio content; and
displaying the stored visual thumbnail.

23. An apparatus for generating a thumbnail corresponding to an audio content, the apparatus comprising:
an analyzer which analyzes the audio content; and
a thumbnail generator which generates a visual thumbnail corresponding to the audio content based on a result of the analyzing by the analyzer.

24. The apparatus of claim 23 wherein the analyzer analyses at least one of additional information and a frequency of the audio content.

25. The apparatus of claim 24 wherein the thumbnail generator generates the visual thumbnail based on the result of the analyzing and function information of an audio content reproducing system capable of reproducing the visual thumbnail.

26. The apparatus of claim 23, further comprising:
a storage unit which stores a visual thumbnail corresponding to the audio content; and
a display unit which displays the stored visual thumbnail.

27. An apparatus for providing a thumbnail of an audio content, the apparatus comprising:
a storage unit which stores a visual thumbnail corresponding to the audio content; and
a display unit which displays the stored visual thumbnail.
